(19) United States
(12) Patent Application Publication
(10) Pub. No.: US 2006/0098063 A1
(43) Pub. Date: May 11, 2006

(54) Ink-jet printing apparatus with configuration of spring and flexible pocket

(76) Inventors: Francis Chee Suen Lee, Hsinchu City (TW); Cheng-Wei Hsu, Yongkang City (TW); Jia-Lin Chen, Hsinchu City (TW); I-Chung Hou, Hsinchu City (TW)

Correspondence Address: RAYMOND Y. CHAN, 108 N. YNEZ AVE., SUITE 128, MONTEREY PARK, CA, 91754, US

(21) Appl. No.: 10/982,981

(22) Filed: Nov. 5, 2004

(51) Int. Cl. B41J 2/175

(52) U.S. Cl. 347/87

(57) ABSTRACT

An ink jet-printing apparatus includes an ink reservoir, a print head, a flexible pocket, and a resilient element. The print head is used for ejecting ink from the reservoir. The reservoir is substantially sealed so that ejection of ink from the reservoir decreases a pressure in the reservoir volume. The flexible pocket is disposed in the ink reservoir and is capable of slowing a decrease of the pressure in the reservoir volume by changing a reservoir volume of a reservoir cavity defined between the flexible pocket and the reservoir. The resilient element is disposed within the ink reservoir and the flexible pocket for maintaining the pressure in the reservoir volume below the ambient pressure. The flexible pocket and the resilient element regulate changes in the negative pressure of the ink-jet printing apparatus.

### BACKGROUND OF THE PRESENT INVENTION

1. Field of Invention

The present invention relates to an ink-jet printing apparatus, and more particularly to an ink-jet printing apparatus with a flexible pocket and a resilient element that is adapted to regulate changes of the negative pressure in the ink-jet printing apparatus.

2. Description of Related Arts

Ink-jet printing apparatus generally involves the controlled delivery of ink drops from an ink-jet pen reservoir to a printing surface (e.g. paper). One type of ink-jet printing apparatus, known as drop-on-demand printing apparatus, employs a pen that has a print head that is responsive to control signals for ejecting drops of ink from the ink reservoir. In this technique, ink is held in the pen at below atmospheric pressure and is ejected by a drop generator on demand. The drop-on-demand techniques require that under quiescent conditions the pressure in the ink reservoir is below the ambient so that ink is retained in the pen until it is to be ejected. The amount of this “negative pressure” (or “back pressure”, or “partial vacuum”, or “underpressure”) is critical. If the negative pressure is too small, or if the reservoir pressure is positive, ink tends to escape through the drop generators. If the negative pressure is too large, air may be sucked in through the drop generators under quiescent conditions.

The negative pressure required in drop-on-demand systems can be obtained in a variety of ways. Past efforts to regulate ink-jet reservoir negative pressure in response to environment changes and operational effects have included various mechanisms that may be collectively referred to as accumulators. Examples of accumulators are described in U.S. Pat. No. 5,039,999 and U.S. Pat. No. 4,992,802. Generally, prior accumulators comprise an elastomeric and cup-like mechanism that defines a volume that is in fluid communication with the ink-jet pen reservoir volume. An accumulator is designed to move relative to the reservoir in response to changes in the level of the negative pressure within the reservoir. However, in the former patent, the interior reservoir volume is generally defined by the rigid walls, the rigid cap, and the rigid piston top. In the later patent, the interior reservoir volume is generally consisted of two portions. The first portion is of fixed volume and is formed by rigid walls. The second portion is of variable volume and comprises a pocket that can be deformed or moved in only one direction mounted behind an opening in one of the rigid walls. Also, there is a spring disposed between the top of reservoir and the flexible pocket end piece.

An alternative technique for achieving the required negative pressure is shown in U.S. Pat. No. 4,509,062. In this patent, the negative pressure is achieved by using a bladder type ink reservoir which progressively collapses as ink is drawn therefrom. The restorative force of the flexible bladder keeps the pressure of the ink in the reservoir slightly below the ambient. This patent also discloses the use of a linear or nonlinear spring outside the bladder for exerting a force on a bladder mechanism which draws back on the ink. Hence, in this patent, the negative pressure could be remained relatively constant by the configuration of the spring and the bladder.

Another alternative technique for achieving the required negative pressure is shown in U.S. Pat. No. 5,359,353. In this patent, change of reservoir volume due to negative pressure extraction of the ink during operation causes lateral collapse of a flexible pocket against outward pressure of a spring arrangement which assists in maintaining negative pressure in the pocket and in centering the pocket in the housing as ink is removed. The spring acts against a pair of plates bonded to the inside surfaces of the pocket urging the walls apart so as to maintain a negative pressure in the ink reservoir pocket. Accordingly, the negative pressure in the ink reservoir maintained at all times by the spring-pocket reliably prevents leakage of ink from the reservoir unless the ink is drawn therefrom by printer operation.

### SUMMARY OF THE PRESENT INVENTION

A main object of the present invention is to provide an improved ink-jet printing apparatus that is adapted to regulate changes in the negative pressure thereof.

Another object of the present invention is to provide an accumulator apparatus for an ink-jet printing apparatus, wherein the flexible pocket could be expanded or contracted to increase or decrease the interior volume of the reservoir cavity to thereby regulate the negative pressure of the interior volume of the reservoir cavity within an operating range that ensures ink will not leak from the print head and that the print head will be able to continue ejecting ink from the ink reservoir on demand.

Another object of the present invention is to provide an accumulator apparatus for an ink-jet printing apparatus, wherein the spring is positioned between ink reservoir and the flexible pocket for obtaining a sufficient minimum negative pressure as the flexible pocket could be expanded or contracted to increase or decrease the interior volume of the reservoir cavity. Use of a spring for this purpose is advantageous because the spring dimensions may be selected to establish any desired negative pressure operation range within the ink reservoir. Accordingly, the spring characteristics (diameter, number of turns, shape, etc.) may be selected to provide a spring constant (k) that affects the flexible pocket movement in a manner that obtains the desired negative pressure within the reservoir volume.

Another object of the present invention is to provide an accumulator apparatus for an ink-jet printing apparatus, wherein the flexible pocket could be contracted to decrease the interior volume of the reservoir cavity to thereby maintain the negative pressure of ink reservoir within an operating range that ensures ink will be delivered from the print head that will be capable of substantially empting the reservoir of ink.

Another object of the present invention is to provide an accumulator apparatus for an ink-jet printing apparatus, wherein the accumulator apparatus is capable of delivering ink during printer operation until the flexible pocket is substantially empty because the flexible pocket is substantially airtight and the withdrawal of ink causes a continuous collapse of the flexible pocket walls inwardly.

Another object of the present invention is to provide an accumulator apparatus for an ink-jet printing apparatus, wherein the flexible pocket basically consists of a resilient material which is closed at the top and opened at the bottom. The flexible pocket is designed to be substantially filled with ink, with the maintenance of the negative pressure therein. Because of the negative pressure, the flexible pocket collapses inwardly upon itself during ink delivery.

Accordingly, in order to accomplish the one or some or all above objects, the present invention provides an ink-jet printing apparatus, comprising:

an ink reservoir;

a flexible pocket configured inside the ink reservoir, the flexible pocket and the ink reservoir defining a reservoir cavity thererbetween, capable of regulating the pressure in the reservoir volume by changing a volume of the reservoir cavity;

a print head for ejecting ink from the reservoir, the reservoir being substantially sealed in such a manner that ejection of ink from the reservoir changes the pressure in the reservoir volume; and

a resilient element disposed between the ink reservoir and the flexible pocket for regulating the pressure in the reservoir volume.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 is an exploded perspective view of an ink-jet printing apparatus according to one embodiment of the present invention.

FIG. 2 is a cross-sectional view of an ink-jet printing apparatus according to a preferred embodiment of the present invention.

FIGS. 3A and 3B are a cross-sectional view of an ink-jet printing apparatus during operation according to the above preferred embodiment of the present invention.

FIG. 4 is an exploded perspective view of an ink-jet printing apparatus according to a first alternative mode of the above preferred embodiment of the present invention.

FIG. 5 is an exploded perspective view of an ink-jet printing apparatus according to a second alternative mode of the above preferred embodiment of the present invention.

FIG. 6 is a cross-sectional view of an ink-jet printing apparatus according to the second alternative mode of the above preferred embodiment of the present invention.

FIG. 7 is a cross-sectional view of an ink-jet printing apparatus according to a third alternative mode of the above preferred embodiment of the present invention.

### DETAILED DESCRIPTION OF THE PREFERRED EMBODIMENT

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The accumulator and related components of the present invention can be positioned in a number of different orientations. As such, the directional terminology is used for purposes of illustration and is in no way limiting. It is to be understood that other embodiments may be utilized and structural or logical changes may be made without departing from the scope of the present invention.

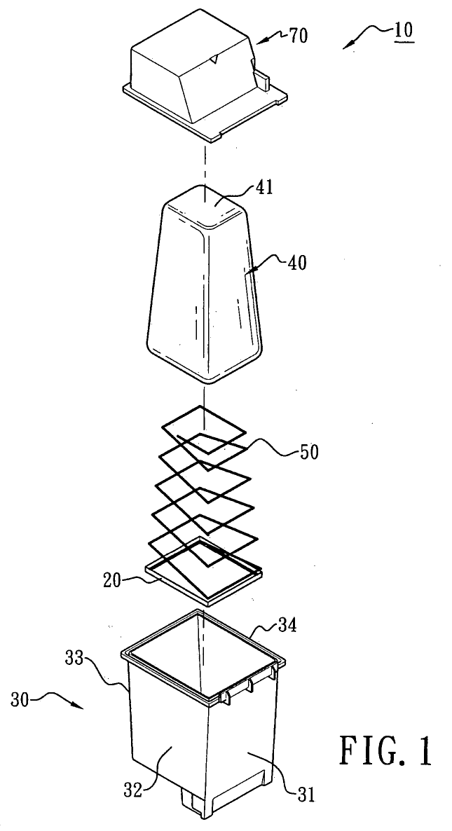

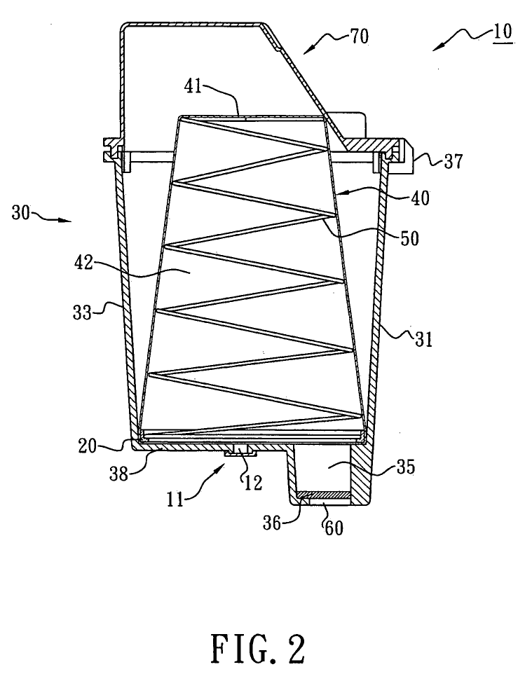

Referring to FIGS. 1 and 2 of the drawings, an ink-jet printing apparatus 10 according to a preferred embodiment of the present invention, in which the ink-jet printing apparatus 10 includes an ink reservoir 30, a flexible pocket 40, a resilient element 50, and a print head 60. The ink reservoir 30 is of fixed volume and is constructed by rigid walls 31, 32, 33, 34, and a bottom wall 38, etc. Extending downwardly from the base of the ink reservoir 30 defines a well 35 with the print head 60 at the bottom thereof. Ink from the ink reservoir 30 is drawn, through a filter 36, into the print head 60 from which it is ejected towards the printing medium by thermal or piezoelectric action, as well known in the prior art.

The flexible pocket preferably is made of expandable and contractible material which is closed at the top and opened at the bottom. Hence the flexible pocket, 40 which functions as an ink storage reservoir, is adhesively and sealedly affixed to the bottom wall 38 of the ink reservoir 30 by, for example, adhesion. A reservoir cavity 42 having a predetermined interior volume is defined between the flexible pocket 40 and the bottom wall 38. The flexible pocket 40 could be of any shape. However, best volumetric efficiency is obtained if the flexible pocket 40 has a shape similar to the configuration of the ink reservoir 30, for example, having a rectangular shape. The following examples use a rectangular flexible pocket to illustrate the embodiments of the invention. Nevertheless, the flexible pocket of this invention is not limited to a rectangular shape and a resilient material. However, a flexible and resilient pocket is a preferred embodiments of the invention that are presently best known to reliably prevent leakage of ink from the reservoir.

A rigid cap 70 is affixed to a top 37 of the sidewalls 31, 32, 33, and 34 of the ink reservoir 30 but not completely airtight-sealed to the top 37 so that the pressure between the flexible pocket 40 and the ink reservoir 30 is the atmospheric pressure. If the rigid cap 70 is completely airtight-sealed to the top 37, there must have a hole located on the rigid cap 70 or other proper position of the ink-jet printing apparatus 10 so that the space between the flexible pocket 40 and the ink reservoir 30 can communicate with the ambient. The resilient element 50 is affixed to the bottom wall 38 of the ink reservoir 30 by, for example, adhesion, or restrained to the bottom wall 38 of the ink reservoir 30 by other proper methods, for example by setting a ring 20 on the bottom wall 38 with the spring 50 mounted within or on the ring. The resilient element 50 extends upwardly from the bottom wall 38 and rests on one end of the undersurface or working surface of the flexible pocket top 41. In other words, the flexible pocket 40 encompasses at least one portion of the resilient element 50. The periphery of the resilient element 50 may be attached to the inside surfaces of the flexible pocket 40 but may be assumed to stay in place without attachment once the assembly is completed. The material of the resilient element 70 can be any material that can be workable and resistant to the corrosion by ink. In the preferred embodiment, the material of the resilient element 70 is the stainless steel.

In operation, the flexible pocket 40 is initially filled with ink through a filling opening 11 which is thereafter sealed with a plug 12. Accordingly, the substantial portion of the ink reservoir 30 will be filled up with the flexible pocket 40 when the flexible pocket 40 is expanded due to the filling of ink. In the preferred embodiment, the initial state of most part of the outside surface of the flexible pocket 40 will be in touch with the part of inside walls of the ink reservoir 30 when the flexible pocket 40 is initially filled with ink. When the ink-jet printing apparatus 10 is printed, ink ejected from the print head 60 leaves a corresponding partial vacuum or negative pressure in the reservoir cavity 42 which causes the flexible pocket 40 to begin collapsing. The collapse of the flexible pocket 40 reduces the interior volume of the reservoir cavity 42 and thus slows the rate at which the partial vacuum builds with continued ejection of ink.

In the preferred embodiment, the resilient element 50 is a rectangle-tapered spring (that is similar to the configuration of the flexible pocket 40). Accordingly, the cross-sectional area of the bottom coil of the rectangle-tapered spring is larger than that of the top coil thereof. Use of a rectangle-tapered spring for this purpose is advantageous because the spring dimensions may be selected to establish any desired negative pressure operation range within the ink reservoir. Accordingly, the spring characteristics (diameter, number of turns, shape, etc.) may be selected to provide a spring constant (k) that affects the flexible pocket movement in a manner that obtains the desired negative pressure within the reservoir volume. Furthermore, the upper end of the rectangle-tapered spring could be compressed downwardly toward the bottom wall 38 until the upper end of the rectangle-tapered spring is in close to or substantially touch with the bottom wall 38. Accordingly, the print head could be able to substantially empty the reservoir of ink.

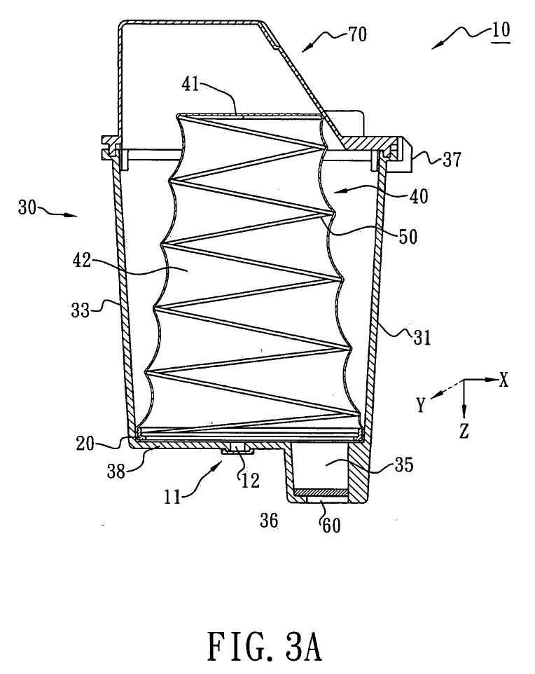

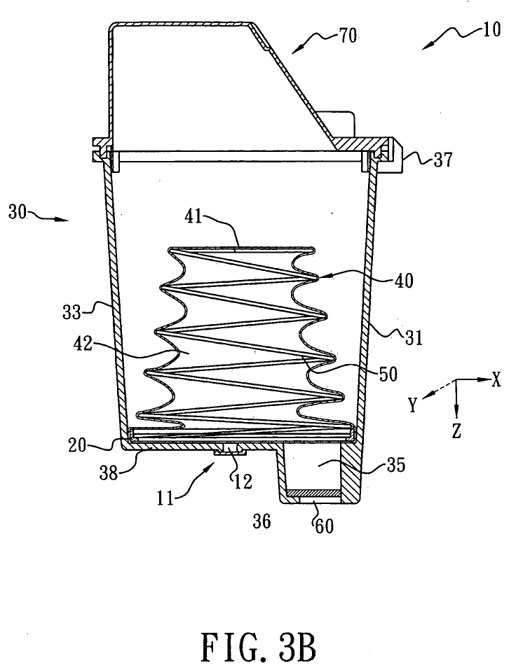

In the preferred embodiment, the initial state of most part of the outside surface of the flexible pocket 40 is in touch with the part of inside walls of the ink reservoir 30 when the flexible pocket 40 is initially filled with ink. Referring to FIGS. 3A and 3B of the drawings, a planar direction is defined by the transverse direction of the bottom wall 38. At first change of interior volume of the reservoir cavity 42 due to negative pressure extraction of the ink during operation may cause lateral collapse of the flexible pocket 40 along the planar direction (i.e. X, Y direction). As the print head 60 is operated to eject ink during printing, the consequent depletion of ink increases (makes more negative) the negative pressure within the flexible pocket 40 and causes the periphery of the resilient element 50 attached to the inside surfaces of the flexible pocket 40. The pressure also acts on the top surface of the flexible pocket 40 (i.e. Z direction) to draw the flexible pocket 40 downwardly toward the bottom wall 38, thereby decreasing the interior volume of the reservoir cavity to keep the negative pressure from increasing to a level so high that the print head 60 would be unable to eject ink from the ink reservoir 30. In other words, in its collapsed (or partially collapsed) state, the resilient element 50 exerts a restorative force (i.e. the reservoir negative pressure) on the flexible pocket 40 which maintains the pressure in the ink reservoir below the ambient.

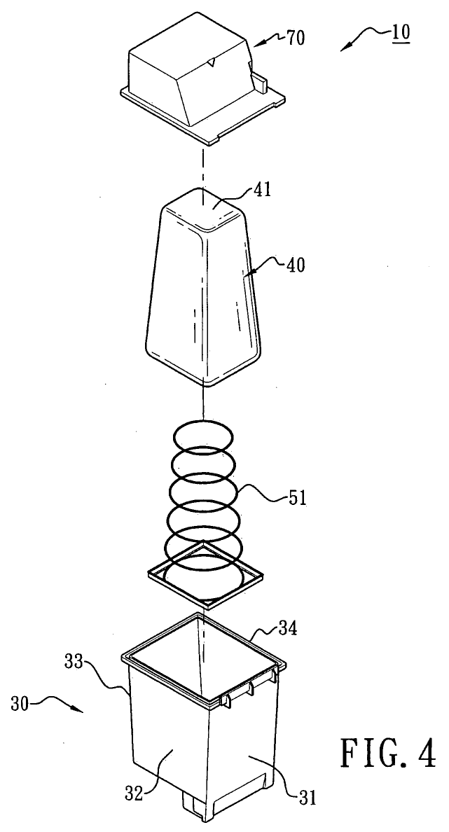

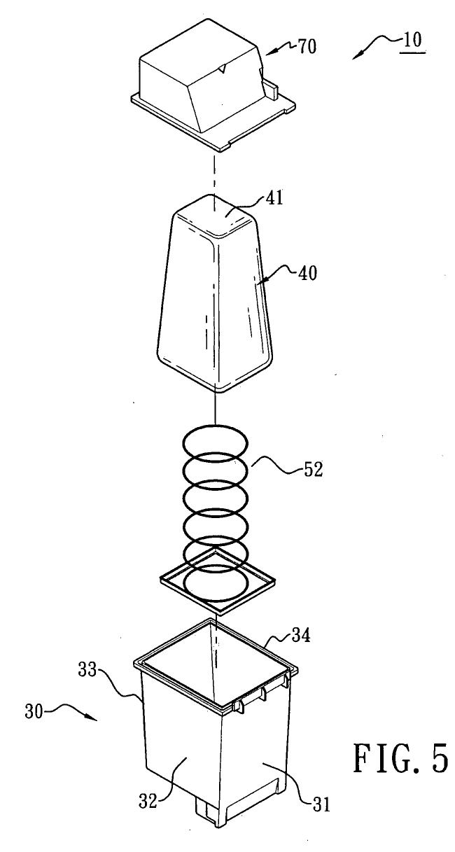

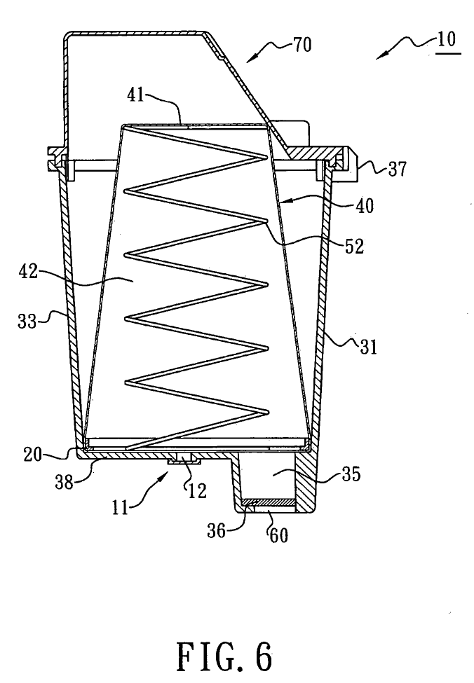

FIGS. 4 through 7 illustrate alternative modes of the above preferred embodiment of the present invention. In this first alternative mode as shown in FIG. 4, the resilient element 51 is a conically-tapered spring. Operation of this alternative mode as shown in FIG. 4 is substantially to the same as that of the preferred embodiment as shown in FIGS. 1, 2, 3A, and 3B. In the second alternative mode as shown in FIGS. 5 and 6, the resilient element 52 is a cylindrical spring. Operation of this alternative mode as shown in FIGS. 5 and 6 is substantially to the same as that of the above preferred mode as shown in FIGS. 1, 2, 3A, and 3B. However, in the alternative mode of FIGS. 5 and 6, the resilient element 52 with the least length of body coils causes that the upper end of the resilient element 52 could not be substantially completely compressed downwardly toward the bottom wall 38 even though ink in the ink reservoir is exhausted.

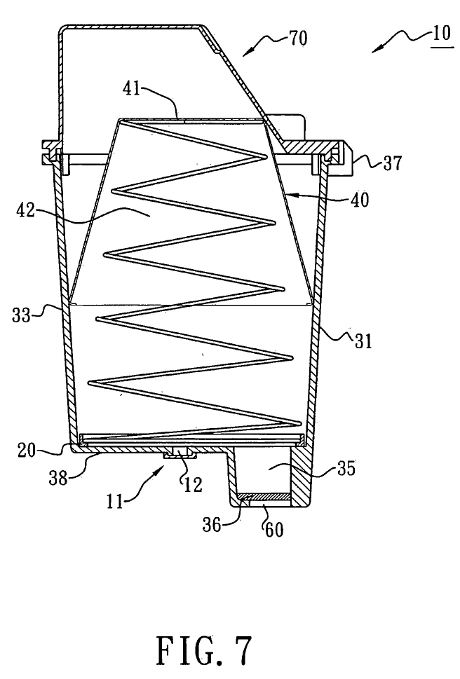

A third alternative mode of the above preferred embodiment of the present invention is illustrated in FIG. 7. In this alternative mode, the flexible pocket 40 which functions as an ink storage reservoir is affixed and sealed to the sidewalls 31, 32, 33, and 34 of the ink reservoir 30 by, for example, adhesion. A reservoir cavity 42 having a predetermined interior volume is defined between the flexible pocket 40 and the bottom wall 38. Operation of this alternative mode as shown in FIG. 7 is substantially to the same as that of the preferred embodiment as shown in FIGS. 1, 2, 3A, and 3B.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. Additionally, the abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

What is claimed is:

1. An ink-jet printing apparatus, comprising:
an ink reservoir;
a flexible pocket disposed in said ink reservoir, wherein said pocket and said ink reservoir defines a reservoir cavity having a predetermined interior volume thererbetween for filling ink therein, wherein said pocket is capable of regulating a pressure in said reservoir cavity by changing said interior volume of said reservoir cavity;
a print head for ejecting ink from said reservoir, which is being substantially sealed in such a manner that ejection of ink from said reservoir changes said pressure in said reservoir cavity; and
a resilient element disposed in said reservoir cavity defined between said ink reservoir and said pocket to regulate said pressure in said reservoir cavity.

2. The ink-jet printing apparatus, as recited in claim 1, further comprising a ring which is set one end of said resilient element.

3. The ink-jet printing apparatus, as recited in claim 1, further comprising a ring which is set one end of said resilient element and mounted within a bottom edge of said pocket.

4. The ink-jet printing apparatus, as recited in claim 1, wherein said resilient element enables said interior volume of said reservoir cavity to contract as ink is ejected therefrom wherein contraction in volume maintains said pressure below an ambient pressure.

5. The ink-jet printing apparatus, as recited in claim 1, wherein said ink reservoir has a filling opening and said pocket is sealedly affixed to a bottom portion of said reservoir while said reservoir cavity communicating with outside through said filling opening of said reservoir.

6. The ink-jet printing apparatus, as recited in claim 5, wherein said resilient element having one end affixed to said bottom wall of said ink reservoir and the other end rested on an inside surface of said pocket top.

7. The ink-jet printing apparatus, as recited in claim 2, wherein said resilient element enables said interior volume of said reservoir cavity to contract as ink is ejected therefrom wherein contraction in volume maintains said pressure below an ambient pressure.

8. The ink-jet printing apparatus, as recited in claim 3, wherein said resilient element enables said interior volume of said reservoir cavity to contract as ink is ejected therefrom wherein contraction in volume maintains said pressure below an ambient pressure.

9. The ink-jet printing apparatus, as recited in claim 1, wherein said resilient element is a tapered spring.

10. The ink-jet printing apparatus, as recited in claim 2, wherein said resilient element is a tapered spring.

11. The ink-jet printing apparatus, as recited in claim 1, wherein said pocket enables said interior volume of said reservoir cavity to contract as ink is ejected therefrom wherein contraction in volume maintains said pressure below an ambient pressure until said pocket reaches a limit of its travel.

12. The ink-jet printing apparatus, as recited in claim 2, wherein said pocket enables said interior volume of said reservoir cavity to contract as ink is ejected therefrom wherein contraction in volume maintains said pressure below an ambient pressure until said pocket reaches a limit of its travel.

13. The ink-jet printing apparatus, as recited in claim 1, wherein said pocket is made of expandable and contractible material.

14. The ink-jet printing apparatus, as recited in claim 1, wherein said pocket is made of flexible material.

15. An ink-jet printing apparatus, comprising:
an ink reservoir;
a flexible pocket disposed in said ink reservoir, wherein said pocket and said ink reservoir defines a reservoir cavity having a predetermined interior volume thererbetween for filling ink therein, wherein said pocket is capable of regulating a pressure in said reservoir cavity by changing said interior volume of said reservoir cavity;
a print head for ejecting ink from said reservoir, which is substantially sealed in such manner that ejection of ink from said reservoir changes said pressure in said reservoir cavity; and
a resilient element having one end affixed and sealed to a bottom wall of said ink reservoir and the other end rested on an inside surface of said pocket top for regulating said pressure in said reservoir cavity.

16. The ink-jet printing apparatus, as recited in claim 15, wherein said ink reservoir has a filling opening and said pocket is sealedly affixed to a bottom portion of said reservoir while said reservoir cavity communicating with outside through said filling opening of said reservoir.

17. The ink-jet printing apparatus, as recited in claim 15, further comprising a ring which is set on said one end of said resilient element.

18. The ink-jet printing apparatus, as recited in claim 15, further comprising a ring which is set one end of said resilient element and mounted within a bottom edge of said pocket.

19. The ink-jet printing apparatus, as recited in claim 15, wherein said resilient element enables said interior volume of said reservoir cavity to contract as ink is ejected therefrom wherein contraction in volume maintains said pressure below an ambient pressure.

20. The ink-jet printing apparatus, as recited in claim 17, wherein said resilient element enables said interior volume of said reservoir cavity to contract as ink is ejected therefrom wherein contraction in volume maintains said pressure below an ambient pressure.

21. The ink-jet printing apparatus, as recited in claim 15, wherein said resilient element is a tapered spring.

22. The ink-jet printing apparatus, as recited in claim 15, wherein said pocket enables said interior volume of said reservoir cavity to contract as ink is ejected therefrom wherein contraction in volume maintains said pressure below an ambient pressure until said pocket reaches a limit of its travel.

23. The ink-jet printing apparatus, as recited in claim 17, wherein said pocket enables said interior volume of said reservoir cavity to contract as ink is ejected therefrom wherein contraction in volume maintains said pressure below an ambient pressure until said pocket reaches a limit of its travel.

24. The ink-jet printing apparatus, as recited in claim 15, wherein said pocket is made of expandable and contractible material.

25. The ink-jet printing apparatus, as recited in claim 15, wherein said pocket is made of flexible material.

26. An ink-jet printing accumulator, comprising:
an ink reservoir;
a flexible pocket disposed in said ink reservoir, wherein said pocket and said ink reservoir defines a reservoir cavity having a predetermined interior volume thererbetween for filling ink therein, wherein said pocket is capable of regulating a pressure in said reservoir cavity by changing said interior volume of said reservoir cavity; and
a resilient element having one end affixed and sealed to a bottom wall of said ink reservoir and the other end rested on an inside surface of said pocket top for regulating said pressure in said reservoir cavity.
